(19) United States
(12) Patent Application Publication
(10) Pub. No.: US 2007/0299667 A1
(43) Pub. Date: Dec. 27, 2007

(54) SYSTEM AND METHOD FOR REDUCING STORAGE REQUIREMENTS FOR A MODEL CONTAINING MIXED WEIGHTED DISTRIBUTIONS AND AUTOMATIC SPEECH RECOGNITION MODEL INCORPORATING THE SAME

(75) Inventors: Lorin P. Netsch, Allen, TX (US); Qifeng Zhu, Plano, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/425,746

(22) Filed: Jun. 22, 2006

(51) Int. Cl. G10L 15/06

(52) U.S. Cl. 704/243

(57) ABSTRACT

A system for, and method of, generating an acoustic model and a mobile communication device that includes an acoustic model having at least one mixture weight vector generated by the method. In one embodiment, the method includes: (1) generating at least one mixture weight vector, (2) re-ordering elements of the at least one mixture weight vector to yield at least one re-ordered mixture weight vector and (3) vector quantizing the at least one re-ordered mixture weight vector to yield at least one quantized re-ordered mixture weight vector.

### TECHNICAL FIELD OF THE INVENTION

The present invention is directed, in general, to weighted distribution models and, more specifically, to a system and method for reducing storage requirements system and method for reducing storage requirements for a model containing mixed weighted distributions and an automatic speech recognition (ASR) model incorporating the same.

### BACKGROUND OF THE INVENTION

With the widespread use of mobile communication devices and a need for easy-to-use human-machine interfaces, ASR has become a major research and development area. Speech is a natural way to communicate with and through mobile communication devices. Unfortunately, mobile communication devices have limited computing resources. Processor speed and memory size limit the size and power of applications that can execute within a mobile communication device. Conventional ASR applications often require a relatively large memory to contain the acoustic models they use to recognize speech.

Conventional ASR applications use Hidden Markov Models (HMMS) with mixture models, often Gaussian Mixture Models (GMMS), to recognize speech. The mixture weights within every GMM form a mixture weight vector. An ASR system often has thousands of GMMs, so the total number of mixture weights is large. It is found a large number of Gaussian mixtures is effective in improving the modeling power and improves recognition performance.

Mixture weights can require a large storage space. Therefore, some approaches have been undertaken to compress mixture weights so they can be stored in systems having relatively small memories, such as mobile communication devices. One conventional approach uses scalar quantization to quantize mixture weights directly (see, e.g., Gupta, et al., “Quantizing Mixture-Weights in a Tied-Mixture HMM,” In Proc. ICSLP (Philadelphia, Pa.), pp. 1828-1831, 1996; Sagayama, et al., “On the Use of Scalar Quantization for Fast HMM Computation,” In Proc. ICASSP, vol. I, pp. 213-216, Detroit, May 1995); and the HTK system from Cambridge University (see, e.g., Young, The HTKBOOK, Cambridge University, 2.1 edition, 1997).

Another conventional approach uses vector or subvector quantization to quantize mixture weight vectors (see, e.g., Digalakis, et al., “Efficient Speech Recognition Using Subvector Quantization and Discrete-Mixture HMMS,” In Proc. IEEE ICASSP′ 99, D Phoenix, Arizona, 1999).

Some more recent approaches quantize the mixture weights using selective quantization, which only quantizes the prominent mixture weights and sets the small ones to a fixed number. Examples include the SRI system (see, Franco, et al., “DynaSpeak: SRI's Scalable Speech Recognizer for Embedded and Mobile Systems,” International Conference of Human language Technology 2002, San Diego, Calif., 2002, pp. 23-26. However, these conventional compression techniques can be improved upon.

Accordingly, what is needed in the art is a more effective way to compress mixture weights for mixture models or other types of models containing weighted distributions. More specifically, what is needed in the art is a way to accommodate larger sets of mixture weights in ASR systems having limited memory, such as mobile communication devices.

### SUMMARY OF THE INVENTION

To address the above-discussed deficiencies of the prior art, the present invention provides a more effective way to compress mixture weights for mixture models, such as GMMs, for such applications as ASR.

### BRIEF DESCRIPTION OF THE DRAWINGS

For a more complete understanding of the invention, reference is now made to the following descriptions taken in conjunction with the accompanying drawings, in which:

FIG. 1 illustrates a high-level schematic diagram of a wireless communication infrastructure containing a plurality of mobile communication devices within which the system and method of the present invention can operate;

FIG. 2 illustrates a histogram of Gaussian mixture weight vectors before re-ordering;

FIG. 3 illustrates a scattered spatial pattern of three selected dimensions of the Gaussian mixture weight vectors of FIG. 2;

FIG. 4 illustrates a block diagram of one embodiment of a system for generating an acoustic model carried out according to the principles of the present invention;

FIG. 5 illustrates a flow diagram of one embodiment of a method of generating an acoustic model carried out according to the principles of the present invention;

FIGS. 6A-6E respectively illustrate histograms of 1^{st}, 3^{rd}, 5^{th}, 7^{th} and 9^{th} Gaussian mixture weights after mixture weight re-ordering; and

FIG. 7 illustrates a scattered spatial pattern of selected dimensions of Gaussian mixture weights after reordering.

### DETAILED DESCRIPTION

Those skilled in the pertinent art should understand that the principles of the present invention may be used to reduce the storage requirements of any model in which distributions (sometimes called “elementary distributions”) are weighted and mixed to form the model. Such models may be used as acoustic models and often employ mixtures of Gaussian distributions when used for that purpose. Though the present has broad applicability, the embodiments set forth in this Detailed Description will be directed specifically to GMMs in the context of ASR.

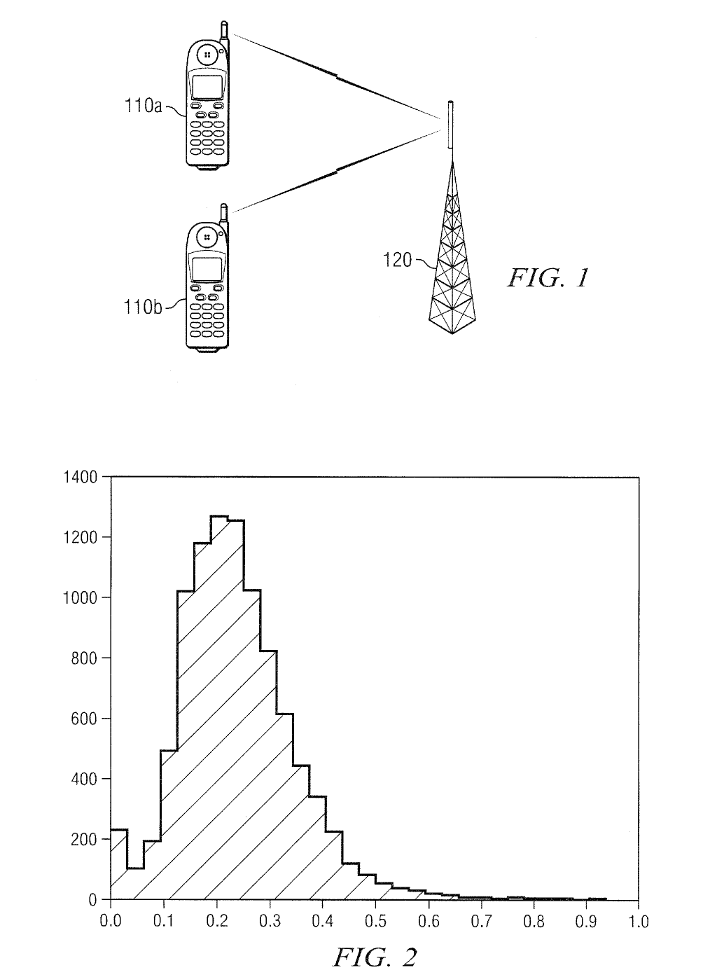

Before describing certain embodiments of the system and the method of the invention, a wireless communication infrastructure in which the novel automatic acoustic model training system and method and the underlying novel state-tying technique of the present invention may be applied will be described. Accordingly, FIG. 1 illustrates a high-level schematic diagram of a wireless communication infrastructure, represented by a cellular tower 120, containing a plurality of mobile communication devices 110a, 110b within which the system and method of the present invention can operate.

One advantageous application for the system or method of the invention is in conjunction with the mobile communication devices 110a, 110b. Although not shown in FIG. 1, today's mobile communication devices 110a, 110b contain limited computing resources, typically a DSP, some volatile and nonvolatile memory, a display for displaying data, a keypad for entering data, a microphone for speaking and a speaker for listening. Certain embodiments of the present invention described herein are particularly suitable for operation in the DSP. The DSP may be a commercially available DSP from Texas Instruments of Dallas, Tex.

Having described an exemplary environment within which the system or the method of the present invention may be employed, some remarks underlying the present invention will now be set forth. The system and method can substantially compress the storage requirements for mixture weights without degrading ASR performance. The system and method are founded on three observations regarding the properties of Gaussian mixture weights:

1. Gaussian mixture weights are not independent; they sum up to one.

2. The distribution of each Gaussian mixture weight is homogeneous along each dimension.

3. Mixture weight order can be changed in the likelihood computation using an appropriate tying scheme.

The system and method first reorders the mixture weights within the mixture weight vector by sorting. A corresponding change of the order of Gaussian distributions should also be made in the HMM-GMM to ensure that the mixture weights correspond to the correct Gaussians. Unless the mixture weights happen by chance to be in a desired order, the sorting reduces or compresses the overall vector space of the mixture weights. The sorting also changes the homogeneous distribution along each dimension to a distribution that is different in each dimension so vector quantization can be used to code the vector space efficiently. As those skilled in the pertinent art understand, vector quantization is based on Euclidean distance. After vector (or subvector) quantization of the mixture weight vectors, post processing can be performed to ensure that the sum of the vector elements equals to one.

In one embodiment of the present invention, 95,000 Gaussian mixture weights, representing 9500 tied states with 10 mixtures per state, can be stored in only 13 Kbytes of memory. This includes the codebook and indices that vector quantization requires. The result is an extremely efficient compression to only 1.09 bits per mixture weight. Without benefit of the present invention, scalar quantization of that many mixture weights typically requires as few as eight or as many as 16 bits per mixture weight, resulting in a total of 95 Kbytes of memory. The proposed method clearly has a significant advantage over scalar quantization and, as will be shown, unsorted vector quantization. This reduction in storage requirement is important for mobile communication devices, where storage is a major concern.

Certain embodiments of the system and method will now be described in greater detail. FIG. 2 illustrates a histogram of elements of Gaussian mixture weight vectors before re-ordering. Typically, each mixture weight distribution is similar in dynamic range. From FIG. 2, it can be seen that a dynamic range of the mixture weights in each dimension of about 0 to 0.5 covers about 99% of the mixture weights. Capturing the outliers would require a dynamic range of almost 0 to 1.0. Vector-quantizing this great a dynamic range results in a less efficient compression.

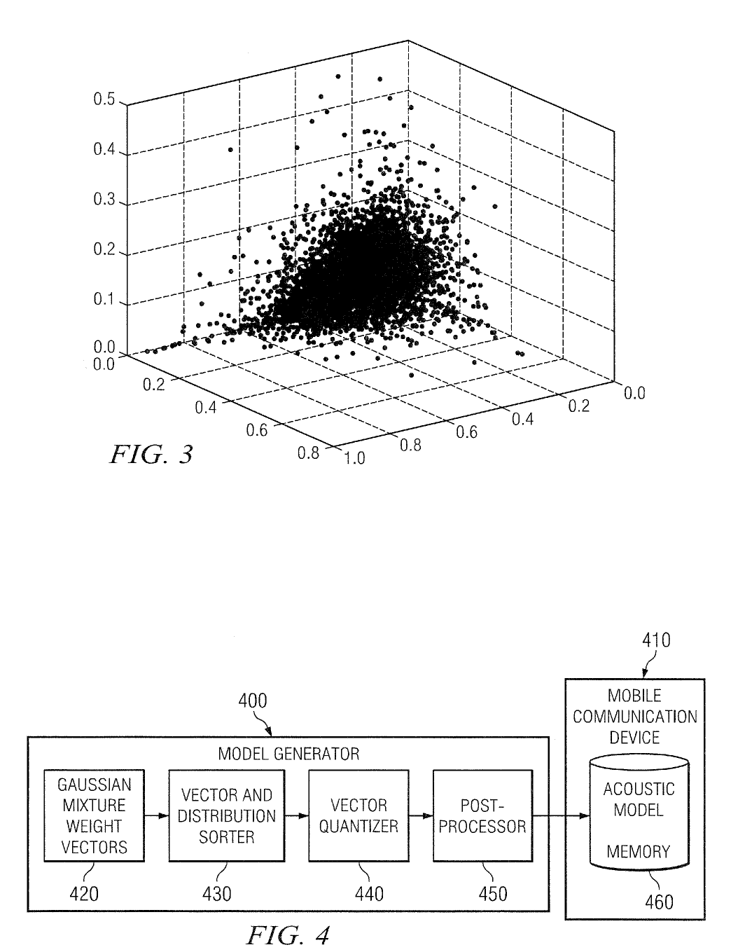

FIG. 3 illustrates a scattered spatial pattern of three selected dimensions of the Gaussian mixture weight vectors of FIG. 2. From FIG. 3, it can be seen that the mixture weights scatter homogeneously along each dimension in the space. It is desired to reduce the dynamic range of the elements that are to be vector quantized. Stated another way, it is desired to reduce the volume over which the mixture weights is scattered.

Turning now to FIG. 4, illustrated is a block diagram of one embodiment of a system for generating an acoustic model carried out according to the principles of the present invention. The particular embodiment of the system illustrated in FIG. 4 is incorporated in a model generator 400, which may be embodied in hardware, software or a combination thereof. The model generator 400 takes as its input at least one (un-sorted, un-quantized) Gaussian mixture weight vector 420.

The at least one Gaussian mixture weight vector 420 is provided to a vector and distribution sorter 430. The vector and distribution sorter 430 is configured to re-order elements of the at least one Gaussian mixture weight vector and corresponding distributions to yield at least one re-ordered Gaussian mixture weight vector. The order of the distributions, e.g., Gaussian distributions, in the acoustic model, are re-ordered so the correct mixture weight continues to be applied to its corresponding distribution.

In one embodiment, the vector and distribution sorter 430 is configured to sort the elements of the at least one Gaussian mixture weight vector to minimize Euclidean distances among elements of the at least one quantized re-ordered Gaussian mixture weight vector. By way of example, the vector and distribution sorter may be configured to sort the elements in ascending order. Alternatively, the vector and distribution sorter may be configured to sort the elements in descending order. Those skilled in the pertinent art will understand, however, that any conventional or later-developed sorting criterion or algorithm may be appropriate for a given application and that all such criteria or algorithms fall within the broad scope of the present invention.

The re-ordered Gaussian mixture weight vector 420 is next provided to a vector quantizer 440 that is associated with the vector and distribution sorter 430. The vector quantizer 440 is configured to vector quantize the at least one re-ordered Gaussian mixture weight vector to yield at least one quantized re-ordered Gaussian mixture weight vector. In a more specific embodiment, the vector quantizer 440 is configured to subvector vector quantize the at least one re-ordered Gaussian mixture weight vector to yield the at least one quantized re-ordered Gaussian mixture weight vector.

The vector quantizer 440 may use any conventional or later-developed vector- (or subvector-) quantization algorithm. The vector quantizer 440 may use, for example, the subvector quantization technique of Digalakis, et al., supra, incorporated herein by reference.

An optional post-processor 450 may be employed to ensure that a sum of the elements of a mixture weight vector equals one. The at least one quantized re-ordered Gaussian mixture weight vector may then be provided to a mobile communication device 410, in which it is stored in a memory 460 thereof as part of an acoustic model. The acoustic model is thereby configured for subsequent use for ASR.

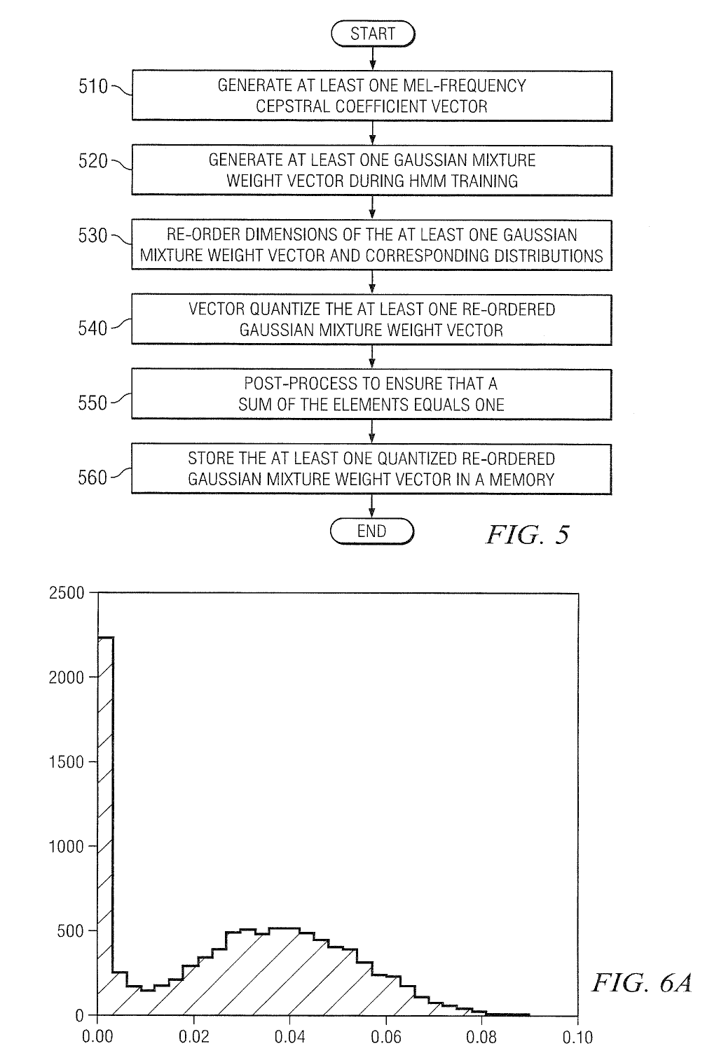

Turning now to FIG. 5, illustrated is a flow diagram of one embodiment of a method of generating an acoustic model carried out according to the principles of the present invention. The method begins in a start step (not referenced), wherein it is desired to generate an acoustic model, perhaps destined for a mobile communication device having limited computing resources.

In a step 510, at least one mel-frequency cepstral coefficient (MFCC) vector or any other feature vector is generated by, e.g., a conventional technique. In a step 520, at least one Gaussian mixture weight vector is generated by, e.g., a conventional technique in HMM-GMM training.

In a step 530, elements of the at least one Gaussian mixture weight vector and corresponding (e.g., Gaussian) distributions are re-ordered to yield at least one re-ordered Gaussian mixture weight vector. The re-ordering may involve sorting the elements of the at least one Gaussian mixture weight vector to minimize Euclidean distances among elements of the at least one quantized re-ordered Gaussian mixture weight vector. The re-ordering may involve sorting the elements in ascending order, descending order or in any conventional or later-discovered manner as may be advantageous to a particular application.

In a step 540, the at least one re-ordered Gaussian mixture weight vector is vector quantized to yield at least one quantized re-ordered Gaussian mixture weight vector. The vector quantizing may involve subvector quantizing the at least one re-ordered Gaussian mixture weight vector. In a step 550, the at least one quantized re-ordered Gaussian mixture weight vector may be post-processed to ensure that a sum of the elements equals one.

In a step 560, the at least one quantized re-ordered Gaussian mixture weight vector is stored in a memory. The memory may be associated with a mobile communication device, for example. The quantized Gaussian mixture weights form part of the acoustic model with which ASR may be performed. The method ends in an end step (not referenced).

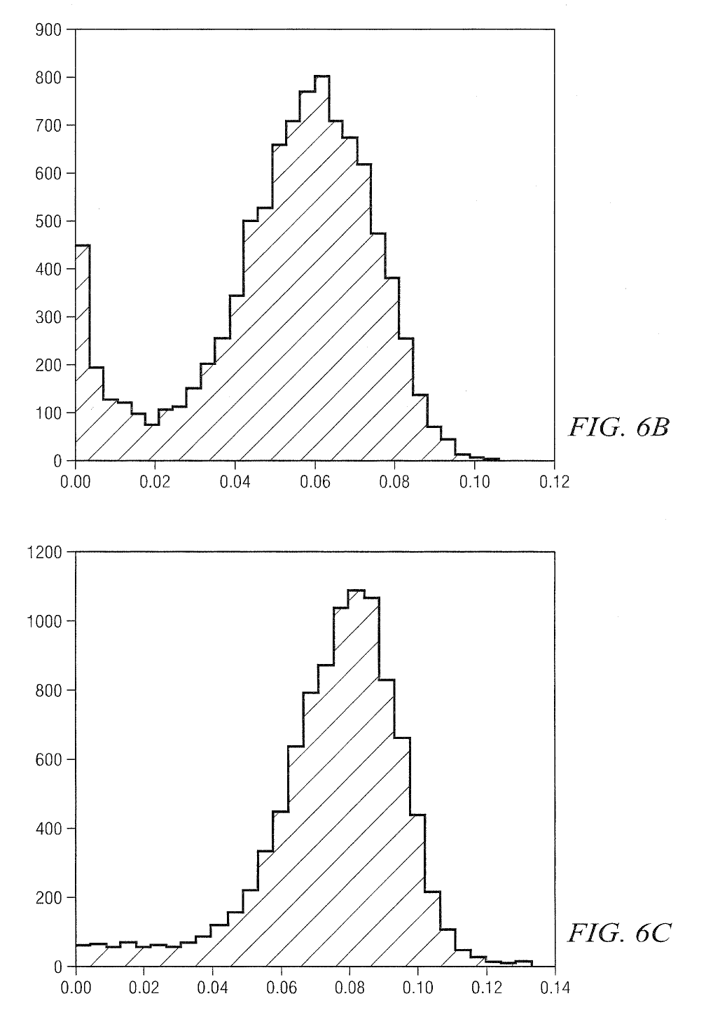

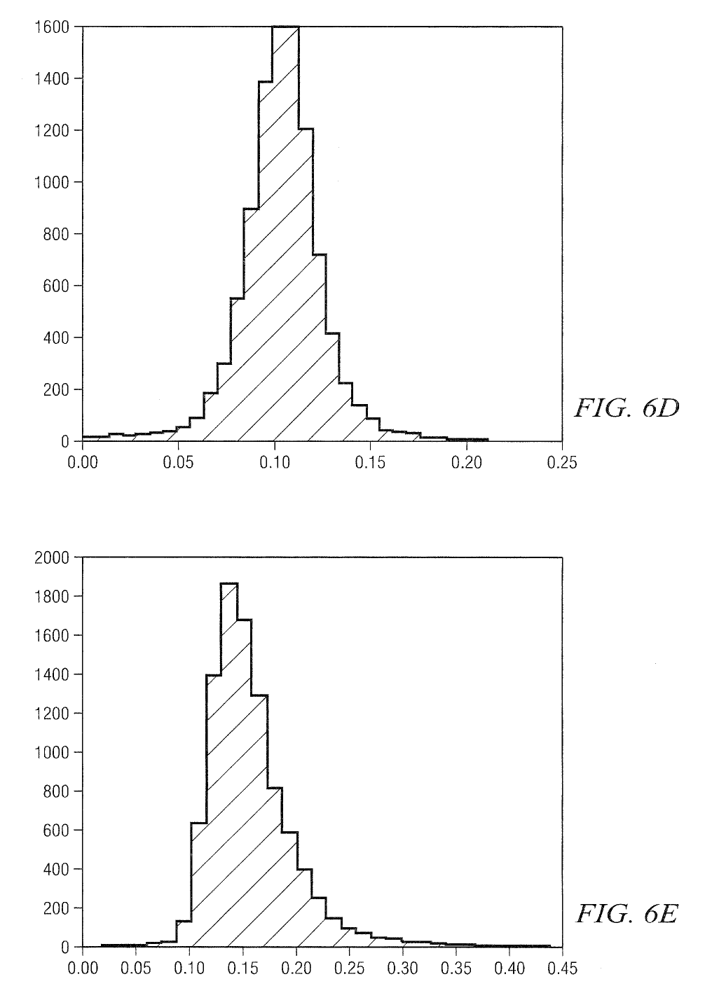

Having described embodiments of systems and methods that fall within the scope of the present invention, graphical data will now be set forth that illustrates application of embodiments of the present invention to actual Gaussian mixture weight vectors. More specifically, FIGS. 6A-6E show histograms of sample Gaussian mixture weights after re-ordering for the 1^{st}, 3^{rd}, 5^{th}, 7^{th} and 9^{th} dimensions of the Gaussian mixture weight vectors.

It will be observed that the dynamic range of each dimension is substantially reduced after re-ordering. To keep 99% of the cases, the dynamic range now can be from 0 to 0.07, 0.09, 0.11, 0.16 and 0.29, respectively, for the 1^{st}, 3^{rd}, 5^{th} 7 and 9^{th} dimensions, and 0.52 for the 10^{th} mixture weights. The greatly reduced dynamic range illustrates the ability to compress the vector space.

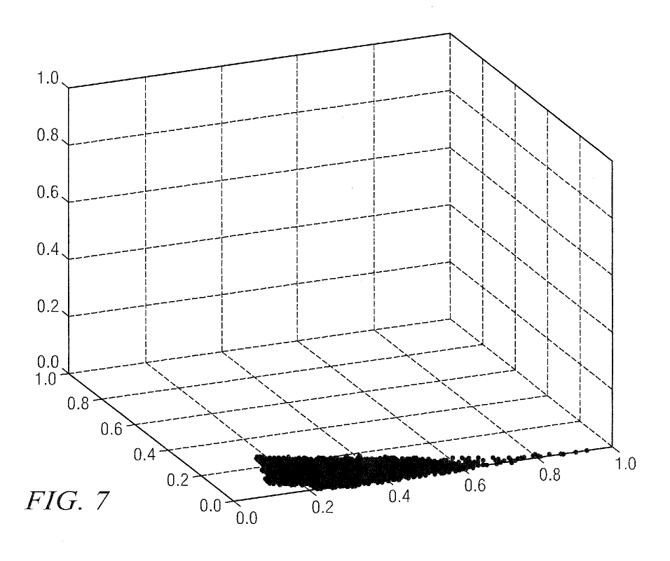

Turning now to FIG. 7, illustrated is a scattered spatial pattern of selected dimensions of Gaussian mixture weights after reordering, more specifically the 1^{st}, 5^{th}, and 9^{th} mixture weights. FIG. 7 demonstrates that, in this example, the distribution of each dimension is no longer homogeneous. Scalar quantization of this distribution would align the vector space parallel to the axes, which would result in suboptimal compression. Vector quantization can take advantage of the tilted border of the vector space. For the scattered spatial pattern of FIG. 7, vector or subvector quantization is a clear choice over scalar quantization.

Although the present invention has been described in detail, those skilled in the art should understand that they can make various changes, substitutions and alterations herein without departing from the spirit and scope of the invention in its broadest form.

What is claimed is:

1. A system for generating a model containing mixed weighted distributions, comprising:
a vector and distribution sorter configured to re-order elements of at least one mixture weight vector and corresponding distributions to yield at least one re-ordered mixture weight vector; and
a vector quantizer associated with said vector and distribution sorter and configured to vector quantize said at least one re-ordered mixture weight vector to yield at least one quantized re-ordered mixture weight vector.

2. The system as recited in claim 1 wherein said model is an acoustic model.

3. The system as recited in claim 1 wherein said vector and distribution sorter is configured to sort said elements of said at least one mixture weight vector to minimize Euclidean distances among elements of said at least one quantized re-ordered mixture weight vector.

4. The system as recited in claim 1 wherein said vector and distribution sorter is configured to sort said elements in ascending order.

5. The system as recited in claim 1 wherein said vector and distribution sorter is configured to sort said elements in descending order.

6. The system as recited in claim 1 wherein said vector quantizer is configured to subvector vector quantize said at least one re-ordered mixture weight vector.

7. The system as recited in claim 1 further comprising a post-processor associated with said vector quantizer and configured to ensure that a sum of said elements equals one.

8. A method of generating a model containing mixed weighted distributions, comprising:
generating at least one mixture weight vector;
re-ordering elements of said at least one mixture weight vector and corresponding distributions to yield at least one re-ordered mixture weight vector; and
vector quantizing said at least one re-ordered mixture weight vector to yield at least one quantized re-ordered mixture weight vector.

9. The method as recited in claim 8 wherein said model is an acoustic model.

10. The method as recited in claim 8 wherein said re-ordering comprises sorting said elements of said at least one mixture weight vector to minimize Euclidean distances among elements of said at least one quantized re-ordered mixture weight vector.

11. The method as recited in claim 8 wherein said re-ordering comprises sorting said elements in ascending order.

12. The method as recited in claim 8 wherein said re-ordering comprises sorting said elements in descending order.

13. The method as recited in claim 8 wherein said vector quantizing comprises subvector quantizing said at least one re-ordered mixture weight vector.

14. The method as recited in claim 8 further comprising post-processing said at least one quantized re-ordered mixture weight vector to ensure that a sum of said elements equals one.

15. A mobile communication device, comprising:
a memory containing an acoustic model including at least one quantized re-ordered mixture weight vector generated by a method including:
generating at least one mixture weight vector,
re-ordering elements of said at least one mixture weight vector and corresponding distributions to yield at least one re-ordered mixture weight vector, and
vector quantizing said at least one re-ordered mixture weight vector to yield said at least one quantized re-ordered mixture weight vector.

16. The device as recited in claim 15 wherein said at least one mixture weight vector is at least one Gaussian mixture weight vector.

17. The device as recited in claim 15 wherein said re-ordering comprises sorting said elements of said at least one mixture weight vector to minimize Euclidean distances among elements of said at least one quantized re-ordered mixture weight vector.

18. The device as recited in claim 15 wherein said re-ordering comprises sorting said elements in ascending order.

19. The device as recited in claim 15 wherein said re-ordering comprises sorting said elements in descending order.

20. The method as recited in claim 15 wherein said vector quantizing comprises subvector quantizing said at least one re-ordered mixture weight vector.

21. The method as recited in claim 13 further comprising post-processing said at least one quantized re-ordered mixture weight vector to ensure that a sum of said elements equals one.
